(19) United States
(12) Patent Application Publication
(10) Pub. No.: US 2025/0346392 A1
(43) Pub. Date: Nov. 13, 2025

(54) STAVE WOOD FOR THE PRODUCTION OF STAVES OF WOOD CONTAINERS

(71) Applicant: NZT, SAINTES (FR)

(72) Inventor: Nicolas TOMBU, LES GONDS (FR)

(21) Appl. No.: 19/199,530

(22) Filed: May 6, 2025

(30) Foreign Application Priority Data
May 7, 2024 (FR) 2404811

(51) Int. Cl. B65D 8/00; B32B 3/06; B32B 21/04; B65D 6/14

(52) U.S. Cl. CPC B65D 9/04; B32B 3/06; B32B 21/042; B65D 9/30; B32B 2439/40

(57) ABSTRACT

A stave wood for the production of a stave of a wood container, having a first layer of a first wood and a second layer of wood. The second layer being a layer of a second wood different from the first wood. The first and second layers of wood being assembled together exclusively by a mortice and tenon joint with no adhesive binder. The face of the second layer opposite that intended to form an exterior face of the stave includes one or more tenons forming a projection thereon extending only along the longitudinal axis of the stave wood. The face of the first layer of wood opposite that is intended to an interior face of the stave includes a corresponding mortice for each tenon of the second layer of wood a extending along the longitudinal axis of the stave wood.

### CROSS-REFERENCE TO RELATED APPLICATIONS

This application is based on and claims priority under 35 U.S.C. § 119 to French Patent Application No. 2404811, filed on May 7, 2024, in the French Intellectual Property Office, the disclosure of which is incorporated by reference herein in its entirety.

### BACKGROUND

### Field

The present disclosure relates to the field of the production of wood containers for ageing and storing liquids, in particular wines or alcoholic drinks such as spirits.

It more particularly concerns a monolithic stave wood for the production of staves of a wood container.

### Brief Description of Related Developments

Ageing in wood casks, in particular oak casks, is considered an essential step in the ageing of wines and spirits.

It is known that wine in a cask impregnates the wood so that chemical compounds that can be extracted from the wood, for example tannins, are released into the wine, conferring on it specific organoleptic characteristics.

Furthermore, slow penetration of oxygen through the wood produces managed oxidation of the compounds present in the wine, positively modifying its organoleptic characteristics.

It is also known that polysaccharides released by the wood reduce the astringency of the wine and that a plurality of flavours, also released by the wood, have a significant impact on the taste of the wine.

The production of wood casks and barrels necessitates know-how and mastery of a plurality of trades.

Firstly, the grower produces the remarkable trees used in cooperage, notably for great wines. The producer of stave wood chooses the relevant trees on foot, in the wood, and transforms the selected logs into stave wood while the cooper works, assembles and heats the planks, or stave wood, obtained from the wood of those trees.

This stave wood undergoes a plurality of operations with a view to the production of a cask in which the skills of the cooper become manifest. This is known in itself.

These operations include machining the edges of the staves at the appropriate angle to produce a seal between the staves of the future cask (referred to as “jointing”). Machining also imparts a tapered shape to the stave.

Shaving consists in shaping an exterior face of the stave in order to generate a convex shape appropriate for the required profiles.

Hollowing consists in shaping the interior face of the stave in order to obtain a concave shape of constant thickness over the entire width of the stave.

Lengths of the stave wood worked in this way are referred to as staves.

The lengths of stave wood or the solid wood planks used to produce the staves typically have a thickness between 22 mm and 45 mm and a length of the order of 80 cm to 130 cm, for instance.

A plurality of these staves are then stood on end by the cooper with the concave face on the inside, the staves being held together at their ends by a thick metal hoop.

Other hoops are then hammered into place by the cooper while the staves of the future container are subject to a step of heating and humidification in such a manner as to be progressively curved by means of a capstan cable.

Once the final shape of the cask has been obtained, it is fixed by hoops at its other end.

Although oak has been always considered as a wood of exceptional quality for vinification and production of wine, other woods can be used, for example chestnut and acacia.

However, for a number of years there has been seen a serious deterioration in the health of oaks and chestnuts in some regions of France.

Tree diseases such as ink disease caused by invasive pathogens are in particular responsible for this deterioration.

Now, not only do climatic conditions, mild winters and wet springs, favour the expansion of these diseases over French territory, as well in some other European countries, but recurring dry summers since 2015 are a source of drying out and thermal stress, which increases tree mortality.

Furthermore, intense meteorological events such as storms can also contribute locally to this significant reduction in the number of certain trees traditionally used in cooperage.

This results in rarity of certain hard woods such as oak, increasing the cost of the wood, all the more so in that other areas of activity such as joinery and construction also exert an increasing pressure on these woods.

Therefore there is a pressing need for improved optimisation of the natural resources that are become rare by limiting the quantity of first quality woods used in cooperage.

There are known from the prior art laths used to form staves that are formed by assembling a plurality of thicknesses glued together. These thicknesses may incorporate a sealing film.

However, we have been forced to notice that the adhesive used to bond these various thicknesses and the sealing film constitute barriers opposing the passage of oxygen through the staves of a container.

Now, as mentioned hereinabove, the porosity of the wood, in particular of oak, enables slow and regular oxygenation of the liquid contained in a cask, which allows certain reactions of oxidation that are of particular interest in the production and ageing of wines and alcoholic drinks.

Eliminating this oxygenation therefore prevents profiting from its multiple beneficial impacts on the wine (colour, nose and structure).

Furthermore, wine experts express a particular reticence in the use in cooperage of these laths produced by gluing together an assembly of thicknesses, fearing possible migration of chemical compounds from the adhesive to the liquid contained in the cask.

These laths therefore have intrinsic drawbacks that are difficult to overcome, ruling out their use in cooperage, in particular for producing and ageing great wines.

### SUMMARY

The present disclosure has for object overcoming the drawbacks of the prior art and addressing the constraints referred to hereinabove by proposing stave wood for the production of wood container staves that is simple in terms of its design and use, made entirely of wood, enabling reduction of the quantity of first quality wood such as oak used in the production of the stave wood.

Another object of the present disclosure is such stave wood in which the layer of wood intended to define the exterior surface of the stave does not risk showing defects, in particular bursting of some of its fibres, when the stave is curved by the traditional heating process.

A further object of the present disclosure is such stave wood in which the assembly of its two constituent layers of wood is facilitated.

A further object of the present disclosure is such stave wood in which the layer of wood intended to define the exterior surface of the stave can be of organoleptic interest because of its intrinsic aromatic compounds.

The present disclosure is also directed to a wood container the staves of which are formed of such stave wood.

To this end, the disclosure concerns a stave wood for the production of staves of wooden containers such as barrels, said stave wood consisting of:
a first layer of a first wood, referred to as the rare wood, one face of which is intended to form the interior face of the stave, the thickness of this first layer of wood being less than or equal to 20 mm, preferably less than or equal to 17 mm, and even better less than or equal to 15 mm,
a second layer of wood one face of which is intended to form the exterior face of the stave, said second layer of wood being a layer of a second wood different from the first wood,
said first and second layers of wood being joined together exclusively by a mortice and tenon joint with no adhesive binder such as a glue, the joint being a negative clearance joint, the second layer of wood having a face, referred to as the assembly face, including one or more tenons forming projections thereon, the first layer of wood including a face referred to as the assembly face including a corresponding mortice for each tenon of the assembly face of the second layer of wood, the mortice or mortices extending along the assembly face of the first layer of wood outside the ends thereof, each of which is intended to receive a kerf or croze for positioning a closing piece or head.

This stave wood is therefore advantageously in one piece, or monolithic, with the result that it can be machined and shaped by the processes traditionally used in cooperage.

This stave wood is obtained by tight mortice and tenon or negative clearance joining of the assembly face of the first layer of wood and the assembly face of the second layer of wood. In other words, these assembly faces are joined together to form the stave wood.

It is of particular interest to halve the thickness of the existing stave wood specified in the professional standards to obtain costly wood thicknesses less than 20 mm.

The original design of the stave wood advantageously makes it possible to minimise the quantity of costly wood or woods of first quality such as oak used as the first layer of wood while excluding possible introduction into the wood of “foreign” chemical substances, resulting for example from the use of adhesive compounds or sealing films.

Thus, while retaining the contribution of the extractible chemical compounds looked for in ageing a wine or an alcoholic drink, the original design of this stave wood minimises the quantity of costly wood used for its formation and oxygenation via this stave wood of the liquid contained in the wood container produced from this stave wood.

Such a design goes against the prejudices of the person skilled in the art. The latter seek in effect to glue together a plurality of layers of wood to create a thick lath, principally for reasons concerning the aesthetics of the finished container and from fear of compromising in particular the seal thereof.

The present teaching procures numerous advantages.

The unit cost of the stave wood is reduced because the quantity of rare wood employed is minimised. There is approximately 40 percent less consumption of quality materials such as oak.

The layers being thinner than in the prior art there is a lower risk of breakage and therefore of loss of material and of repair time during heating (curving step).

It is possible to use a local wood for the second layer of wood, that is to say a raw material from near the cooperage, which significantly reduces procurement costs.

The high mechanical strength of the staves formed from the stave wood described hereinabove after demounting has also been noted, enabling export of dismantled wood containers.

In one particular aspect of this stave wood the face of said second layer opposite that intended to form the exterior face of the stave, referred to as the assembly face, includes one or more tenons projecting therefrom and extending along the longitudinal axis of said stave wood, the face of the first layer of wood opposite that intended to form the interior face of the stave including a corresponding mortice for each tenon of the assembly face of said second layer of wood extending along the longitudinal axis of said stave wood.

This disposition of the mortices and tenons along the longitudinal first and second layers of wood has a two-fold role.

Firstly, it guarantees when curving the stave by heating it a freedom of movement of the second layer relative to the first layer in the longitudinal direction of these layers, with the result that the second layer, subjected to greater curvature than the first layer, does not risk showing defects, in particular bursting of some of its wood fibres.

Furthermore, the wine in a barrel is typically in contact with the radial longitudinal surface of the oak wood and because of this the numerous medullary rays of the wood are considered as forming natural barriers against diffusion of the liquid in a direction tangential to the wall of the body of the barrel.

These medullary rays are important for guaranteeing the impermeability to wine of a stave because disposing the mortice or mortices in the longitudinal direction of the first layer of wood reduces the risk of leaks occurring.

In another aspect of this stave wood the wood of the first layer is oak or chestnut.

In a further aspect of this stave wood the wood constituting the first layer of wood having a specific gravity d₁, the wood constituting said second layer of wood has a specific gravity d₂ less than or equal to the specific gravity di of the wood constituting the first layer of wood.

In known manner the specific gravity of the dry wood in air, referred to as the “specific gravity of the wood”, is the ratio between the mass and the volume of the sample at approximately 12 percent humidity.

For example, oak has a specific gravity of 0.74, beech a specific gravity of 0.71, ash a specific gravity of 0.68 and beech a specific gravity of 0.64 (https://tropix.cirad.fr/fichesdisponibles).

The wood constituting the second layer of wood is preferably chosen in the group comprising ash, beech, hornbeam, acacia, or a resinous wood or an exotic wood such as fuma or fromager wood.

The second layer of wood is preferably dry, or even very dry, to prevent the risk of the joints opening over time. The maximum moisture content of the wood constituting the second layer is less than or equal to 15%, or even better between 12% and 15%.

It is therefore possible to use wood liable to impart one or more particular flavours to the liquid contained in the wood container. For instance, this can mean exotic woods such as lemon tree wood, eucalyptus wood or cedar wood.

It is therefore possible from the flavour point of view to add an “exterior skin” (second layer of wood) made of wood imparting a flavour.

In a further aspect of this stave wood each tenon has a cross section of rectangular shape, semi-circular at the ends, or of trapezoidal, double tenon, omega or cylindrical shape, and is adapted to cooperate with a corresponding mortice or recess with a cross section of complementary shape formed in the assembly face of the first layer of wood.

Alternatively, each tenon can extend vertically from the assembly face of the second layer of wood and have a cross section of trapezium shape, being arranged to cooperate with a recess that has a complementary trapezium shape cross section, or, their profiles being conjugate, formed in the assembly face of the first layer. In the latter case this is a dovetail assembly.

In a further aspect of this stave wood each tenon has a trapezium shape cross section, this tenon having rounded corners. The risk of the wood bursting during curving of the stave wood is therefore advantageously limited.

It could further be a question of a dovetail assembly with male and female rounded omega shapes or male and female rounded C shapes.

In a further aspect of this stave wood the first layer of wood has a minimal thickness greater than or equal to the sum of the depth of penetration of the liquid into the first wood, the maximum mortice depth and a safety thickness between 1 mm and 4 mm, even better between 2 mm and 4 mm. This safety thickness, also referred to as a buffer zone, advantageously makes it possible to prevent leaking of liquid over time through the first layer of wood.

In a further aspect of this stave wood the thickness of the first layer of wood is between 12 mm and 17 mm, preferably between 12 mm and 15 mm, and even better between 13 mm and 15 mm.

In a further aspect of this stave wood the thickness of said second layer, including the tenons, is equal or substantially equal to that of said first layer of wood.

This exterior layer could therefore have a thickness of the order of 15 mm before machining. Having no sealing function, such a thickness of the second layer of wood would enable further saving in terms of the wood resource.

In a further aspect of this stave wood the mortice or mortices extend(s) along the assembly face of the first layer of wood apart from at the ends of the latter.

In effect, the ends of the stave wood are intended during a trimming step to receive a kerf or croze for axial positioning of a closing element referred to as a head.

This avoids the risk of loss of one or both ends of the first layer of wood when material is removed to define the kerfs intended to receive the heads of the container.

In a further aspect of this stave wood each mortice is continuous or non-discontinuous, that is to say not formed of separate mortice portions. Each mortice preferably extends longitudinally in the central portion of the first layer

of wood, that is to say apart from at the ends of the assembly face of this first layer of wood.

There is seen improved mechanical strength of the stave wood obtained in this way.

Alternatively, the stave or staves could be spaced from one another in the longitudinal direction of the first layer of wood, for example by being arranged in a quincunx.

In a further aspect of this stave wood, the first layer of wood including at least three mortices, these mortices are regularly or irregularly spaced across the width of the first layer of wood.

In a further aspect of this stave wood, each tenon having a cross section of rectangular shape, at least one of the longitudinal ends of each tenon includes a bevel or inclined end portion while the corresponding end or ends of each mortice include(s) an inclined part complementary to that of the corresponding tenon, or, their profiles being conjugate, to enable their progressive interengagement. This configuration of the mortices and tenons facilitates joining the assembly faces of the first and second layers of wood.

In a further aspect of the stave wood the first layer of wood has a constant or substantially constant thickness along its longitudinal dimension, the first layer and the second layer having identical lengths before curving.

More generally, the present disclosure also concerns stave wood for the production of staves of wood containers such as barrels, said stave wood consisting of:
a first layer of a first wood, referred to as the rare wood, one face of which is intended to form the interior face of the stave,
a second layer of wood, one face of which is intended to form the exterior face of the stave, said second layer being a layer of a second wood different from the first wood,
said first and second layers of wood being assembled together only by a mortice and tenon joint,
the face of said second layer opposite that intended to form the exterior face of the stave, referred to as the assembly face, including one or more tenons projecting therefrom, the face of the first layer of wood opposite that intended to form the interior face of the stave including a corresponding mortice for each tenon on the assembly face of said second layer of wood.

The present disclosure also concerns a wood container for producing or ageing a liquid such as wine or an alcoholic drink, for example a spirit. According to the disclosure the staves forming the body of this container are made of stave wood as described above. This stave wood has advantageously been worked using traditional cooperage techniques to form the staves.

In known manner, the body of this container constitutes a substantially cylindrical open rigid frame that consists of a plurality of wood staves joined together by means of at least one hoop clamping these staves edge to edge or edge surface to edge surface. The body of this container is closed at both ends.

Such a container can have different volumes and shapes. It may be a cask, a barrel, a keg, a tun, etc.

The interior face of the cross section of each stave of this container is advantageously straight or substantially straight.

Thus the interior face of the stave is not hollowed beforehand to remove some thickness with a view to facilitating curving it.

It is therefore advantageously possible to retain the maximum of material where necessary.

The present disclosure also concerns a method of producing a wood container for producing or ageing a liquid such as wine or an alcoholic drink, for example a spirit, including at least the following steps:
procuring a batch of stave wood as described above,
machining each stave wood from this batch to form identical staves having the same configuration without removing material from the free face of the first layer of wood apart from its ends, in order to form bevels and kerfs or crozes in the corresponding stave.

This method therefore includes a step of machining each stave produced from a batch of stave wood in order to form identical staves. It is preferably here a question of forming staves with the same dimensions and having the same configuration or geometry, this machining step being carried out without hollowing the interior face of the stave or the free face of the first layer of wood, which is the face opposite its assembly face.

This machining step can include a substep of machining each longitudinal edge or edge surface of the stave wood to produce the slope of the joints. This substep is also referred to as “jointing”.

It can also include a machining substep consisting in producing the convex part of the exterior face of the stave, i.e. the free face of the second layer of wood, which is the face opposite its assembly face. This substep is also referred to as “shaving”.

Of course, the stave undergoes a curving step after the machining step.

This production method can also include a step of aromatic heating of the interior of the first layer of wood.

The container production process is therefore faster while retaining as much hardwood as possible.

More generally, the present disclosure further concerns a stave wood for the production of staves of wood containers such as barrels, said stave wood consisting of:
a first layer of a first wood, referred to as the rare wood, one face of which is intended to form the interior face of the stave, the thickness of the first layer of wood being less than or equal to 20 mm, preferably less than or equal to 17 mm, and even better less than or equal to 15 mm,
a second layer of wood one face of which is intended to form the exterior face of the stave, said second layer consisting of a second wood different from the first wood,
joining said first and second layers of wood together exclusively by a mortice and tenon joint with no adhesive binder such as a glue,
the face of said second layer opposite that intended to form the exterior face of the stave, referred to as the assembly face, including one or more tenons forming projections thereof, the face of the first layer of wood opposite that intended to form the interior face of the stave including a corresponding mortice for each tenon on the assembly face of said second layer of wood.

This stave wood is therefore advantageously in one piece, or monolithic, so that it can be machined and shaped by methods traditionally used in cooperage.

It is of particular interest to halve the thickness of the existing stave wood specified in the standards of the profession to obtain thicknesses of wood less than 20 mm.

The original design of this stave wood advantageously makes it possible to minimise the quantity of costly wood or wood of first quality such as oak used in the production of the first layer of wood while excluding the possibility of adding chemical substances “foreign” to the wood resulting for example from the use of adhesive compounds or sealing films.

While maintaining the contribution of the extractable chemical compounds looked for in ageing a wine or an alcoholic drink, the original design of this stave wood therefore minimises the quantity of costly wood used to produce it and to oxygenate the liquid contained in the wood container formed from this stave wood through this stave wood.

Such a design goes against the prejudices of persons skilled in the art. The latter in effect wish to glue together a plurality of layers of wood to create a thick lath, principally for reasons of the aesthetics of the finished container and for fear of compromising in particular the seal thereof.

In a further aspect of this stave wood each tenon extends vertically from the assembly face of the second layer of wood and has a cross section of rectangular shape adapted to cooperate with a corresponding complementary recess having a rectangular shape cross section formed in the assembly face of the first layer, the assembly being a negative clearance assembly.

Alternatively, each tenon can extend vertically from the assembly face of the second layer of wood and have a cross section of trapezium shape adapted to cooperate with a recess having a complementary trapezium shape cross section formed in the assembly face of the first assembly layer. In the latter case, this is a dovetail assembly.

In a further aspect of this stave wood, each tenon having a cross section of trapezium shape, this tenon has rounded corners. This therefore and advantageously limits the risk of the wood bursting during curving of the stave wood.

The assembly can further be a dovetail assembly with male and female rounded omega shapes or male and female rounded C shapes.

In a further aspect of this stave wood the first layer of wood has a minimal thickness greater than or equal to the sum of the depth of penetration of the liquid into the first wood, the maximal mortice depth and a safety thickness of between 1 mm and 4 mm, better between 2 mm and 4 mm. This safety thickness, also referred to as a buffer zone, advantageously makes it possible to prevent leakage of the liquid over time through the first layer of wood.

In a further aspect of this stave wood the thickness of the first layer of wood is between 12 mm and 17 mm, preferably between 12 mm and 15 mm, even better between 13 mm and 15 mm.

In a further aspect of this stave wood the thickness of said second layer, including the tenons, is equal or substantially equal to that of said first layer of wood.

This exterior layer could therefore have a thickness of the order of 15 mm before machining. Having no sealing function, such a thickness of the second layer of wood would make possible further saving in terms of the wood resource.

In a further aspect of this stave wood the mortice or mortices extend(s) along the assembly face of the first layer of wood apart from the ends thereof.

### BRIEF DESCRIPTION OF THE FIGURES

Other advantages, aims and particular features of the present disclosure will emerge from the following description given by way of non-limiting explanation only and with reference to the appended drawings, in which:

FIG. 1 is an exploded perspective view of stave wood in accordance with a first particular aspect of the present disclosure, this view showing the mortices of the first layer of wood, the joint between the first layer of wood and the second layer of wood being a tight mortice and tenon joint or a negative clearance joint;

FIG. 2 is another exploded perspective view of the stave wood depicted in FIG. 1, this view showing the tenons of the second layer of wood;

FIG. 3 depicts a stave wood in accordance with a second aspect of the present disclosure, the joint between the first layer or wood and the second layer of wood being a dovetail joint, the single tenon extending vertically from the assembly face of the second layer of wood and having a cross section of trapezium shape with rounded corners;

FIG. 4 is an exploded perspective view of stave wood according to a third aspect of the present disclosure, the joint between the first layer of wood and the second layer of wood constituting an assembly with male and female rounded omega shapes;

FIG. 5 is a view in section of the stave depicted in FIG. 4, this view showing the tenons forming a projection from the assembly face of the second layer of wood and the mortices of the first layer of wood, these mortices and tenons having respective cross sections with male and female rounded omega shapes;

FIG. 6 is a profile view of a stave formed from the stave wood depicted in FIG. 4, this stave being machined and shaped, or curved, to give the shape of the body of the wood container;

FIG. 7 is a perspective view of a wood container the body of which is obtained from a set of staves formed of the stave wood depicted in FIG. 4.

### DETAILED DESCRIPTION

The drawings and the following description essentially contain elements of a definite character. They could therefore serve not only to explain the present disclosure better but also contribute to its definition if necessary.

Firstly, note that the figures are not to scale.

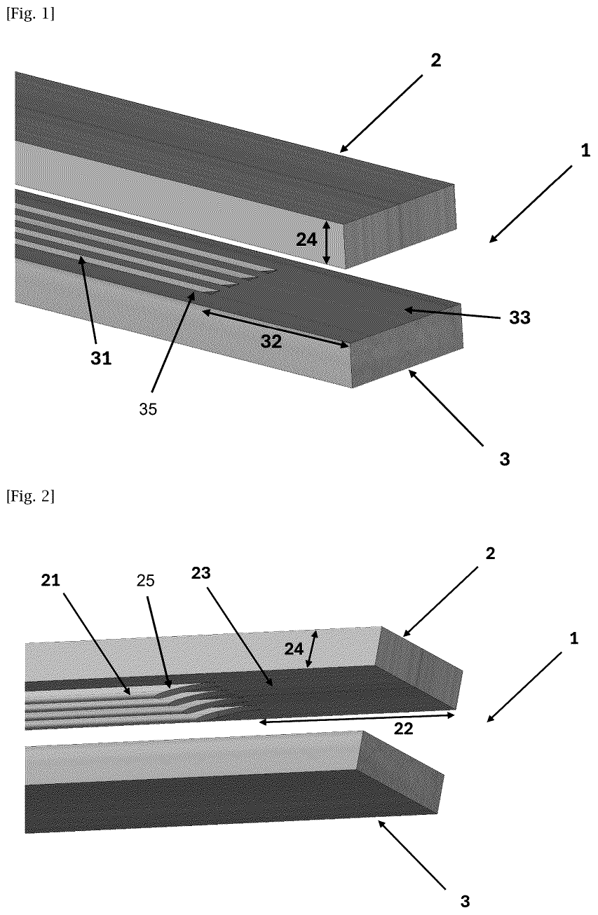

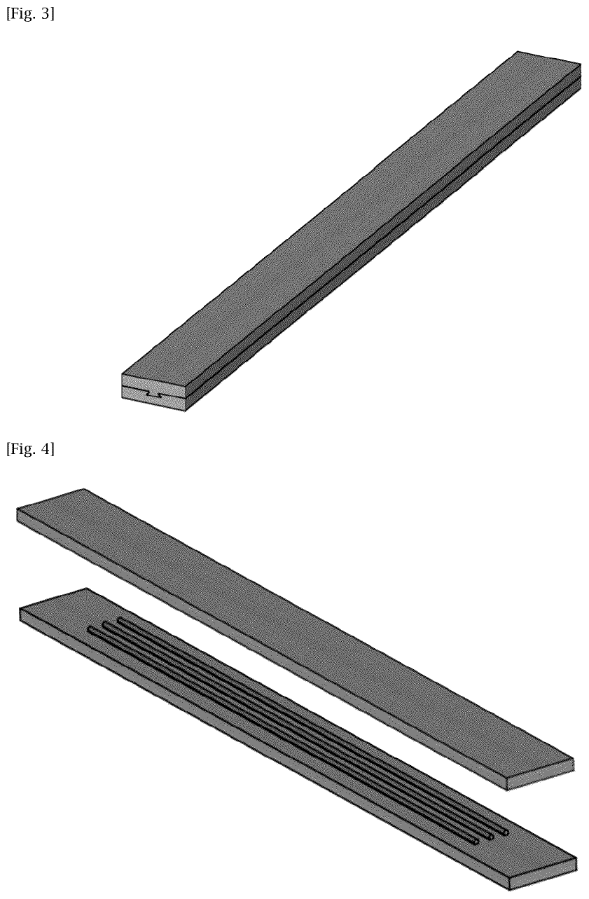

FIGS. 1 and 2 depict diagrammatically a stave wood in accordance with one particular aspect of the present disclosure.

This stave wood 1 consists of a first layer 3 of wood, here French oak, and a second layer 2 of wood, here ash, that are joined together by a tight mortice and tenon joint or a negative clearance joint.

Here by “tight joint” is meant that the clearance is negative and that this assembly of two layers 2, 3 of wood therefore has to be produced forcibly by means of a press, for example. This type of joint is particularly strong.

The two layers 2, 3 of wood have mechanical assembly elements 21, 31 on their assembly faces 23, 33, that is to say the surfaces in contact when the layers are assembled together.

The face of the first layer 3 of wood opposite its assembly face 33 is intended to form the interior face of the stave, the thickness of this first layer 3 of wood being of the order of 15 mm here.

It is therefore possible to use existing pieces of standard stave wood 32 mm thick to convert them into two pieces 14-15 mm thick.

In the same way, for 600 L to 800 L barrels coopers traditionally use pieces of stave wood 38 to 45 mm thick that can be split easily without losing their respective integrities.

The face of the second layer 2 of wood opposite its assembly face 23 is intended to form the exterior face of the stave, this second layer 2 having a minimal thickness 24 outside of its assembly elements 21 equal to that of the first layer 3 of wood.

These two layers 2, 3 of wood are assembled together exclusively by a mortice and tenon joint without using an adhesive binder such as a glue.

Here the face 23 of the second layer 2 includes four tenons 21 regularly spaced across the width of the layer and extending longitudinally in a central part of this second layer 21.

The ends of this second layer 2 therefore include no mechanical assembly element 21 over a certain distance 22.

Each of these tenons 21 therefore forms a projection on the assembly face 23 extending along the longitudinal axis of the second layer 2 and having a cross section of rectangular shape in its central part. Each end of each tenon 21 has an inclined portion 25.

This second layer 2 of wood has a maximum relative humidity between 12% and 15% to prevent the joints from opening up over time.

The assembly face 33 of the first layer 3 of wood includes for each tenon 21 of the assembly face 23 of the second layer 2 of wood a corresponding mortice 31 extending along the longitudinal axis of the first layer of wood. The ends of each mortice 31 include in a manner symmetrical with respect to the corresponding tenon 21 an inclined portion 35 complementary to the inclined portion 25 of the corresponding tenon 21.

Similarly, each mortice 31 is continuous and extends in a central part of the first layer 3 of wood so that the ends 22, 32 of the two layers 2, 3 of wood assembled in this way are not linked together.

Over a certain distance 32 the ends of the assembly face 31 of the first layer 3 of wood are therefore complete and of rectangular section, having no mortice 31.

These ends could advantageously be machined to form kerfs 4 for fixing the end parts 5 of the cask without weakening the stave.

It can be seen that, the first layer 3 of wood receiving only mortices 31 produced within its thickness, this first layer 3 of costly wood includes no mechanical assembly elements forming projections or tenons. Its thickness is therefore maintained at a minimum, here 15 mm. By way of example only, here each mortice 31 has a mortice depth of 5 mm.

The stave formed in this way consisting of two mechanically joined layers 2, 3 of wood has increased durability compared to a glued assembly.

A second layer 2 of wood is advantageously a layer of a wood that is more flexible than the first layer 3 of wood. During the hooping step that is necessary for producing a barrel this makes it possible to distribute the compression forces of the hoops on the first layer of wood in order to minimise the risk of breakage. The wood used to produce the first layer of wood is preferably oak, which is a strong wood.

Alternatively, the second layer 2 of wood can consist of a very hard wood having a maximum relative humidity between 12% and 15%.

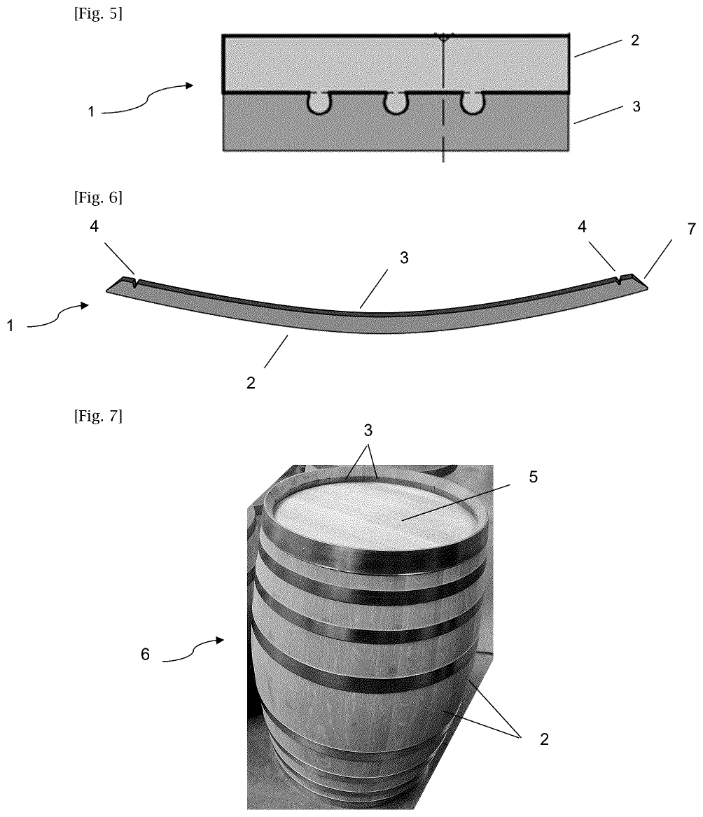

FIGS. 4 and 5 represent a stave wood according to a third aspect of the present disclosure, the assembly between the first layer of wood and the second layer of wood being a male and female omega joint. It is considered a dovetail joint with rounded corners.

These mortices and tenons extend longitudinally in the central parts of the first and second layers excluding their end portions (the final eight centimetres at each end).

FIG. 6 is a profile view of a stave formed from the stave wood depicted in FIG. 4, this stave being machined and shaped, or curved, to impart the shape of the body of the wood container. This stave includes at its ends two bevels 7 and two kerfs 4, also referred to as crozes, intended to receive the conjugate profile edges of the heads 5.

1. A stave wood for the production of staves of wood containers such as barrels, said stave wood consisting of:
a first layer of a first wood, referred to as the rare wood, one face of which is intended to form the interior face of the stave, the thickness of this first layer of wood being less than or equal to 20 mm, preferably less than or equal to 17 mm, and even better less than or equal to 15 mm,
a second layer of wood one face of which is intended to form the exterior face of the stave, said second layer of wood being a layer of a second wood different from the first wood,
said first and second layers of wood being joined together exclusively by a mortice and tenon joint with no adhesive binder such as a glue, the joint being a negative clearance joint,
the second layer of wood having a face, referred to as the assembly face, including one or more tenons forming projections thereon, the first layer of wood including a face referred to as the assembly face including a corresponding mortice for each tenon of the assembly face of the second layer of wood, the mortice or mortices extending along the assembly face of the first layer of wood outside the ends thereof, each of which is intended to receive a kerf or croze for positioning a closing piece or head.

2. The stave wood according to claim 1 characterised in that the assembly face of the second layer of wood includes one or more elongate tenons projecting from this assembly face, this tenon or each of these tenons extending along the longitudinal axis of said stave wood.

3. The stave wood according to claim 1, characterised in that the first layer of wood is a layer of oak or chestnut.

4. The stave wood according to claim 1 characterised in that the wood constituting the first layer of wood having a specific gravity, the wood constituting said second layer of wood has a specific gravity less than or equal to the specific gravity of the wood constituting the first layer of wood.

5. The stave wood according to claim 1 characterised in that the wood constituting the second layer of wood is chosen in the group comprising ash, beech, hornbeam, acacia or a resinous wood or an exotic wood such as fuma or fromager wood, lemon tree wood, eucalyptus wood and cedar wood.

6. The stave wood according to claim 1 characterised in that each tenon has a cross section of rectangular shape, semi-circular at the ends, or trapezoidal, double tenon, omega or cylindrical shape, and is adapted to cooperate with a corresponding mortice or recess with a cross section of complementary shape formed in the assembly face of the first layer of wood.

7. The stave wood according to claim 6 characterised in that, each tenon having a cross section of trapezium shape, this tenon has rounded corners.

8. The stave wood according to claim 1 characterised in that the maximum relative humidity of the wood constituting the second layer is less than or equal to 15% and even better between 12% and 15%.

9. The stave wood according to claim 1 characterised in that the thickness of the first layer of wood is between 12 mm and 17 mm, preferably between 12 mm and 15 mm, and even better between 13 mm and 15 mm.

10. The stave wood according to any one of the preceding claims claim 1 characterised in that the thickness of said second layer of wood is equal or substantially equal to that of said first layer of wood.

11. The stave wood according to any one of the preceding claims claim 1 characterised in that each mortice is continuous and extends longitudinally in the central portion of the first layer of wood.

12. The stave wood according to claim 1 characterised in that, the first layer of wood including at least three mortices, said mortices are regularly spaced across the width of the first layer of wood.

13. The stave wood according to claim 1 characterised in that at least one of the longitudinal ends of each tenon on the assembly face of the second layer of wood includes a bevel or inclined end portion while the corresponding end or ends of each mortice in the assembly face of the first layer of wood include(s) an inclined part complementary to that of the corresponding tenon to enable their progressive interengagement.

14. A wood container for producing or ageing a liquid such as wine or an alcoholic drink characterised in that the staves forming the body of this container are made from stave wood according to claim 1.

15. A method of producing a wood container for producing or ageing a liquid such as wine or an alcoholic drink, including at least the following steps:
procuring a batch of stave wood according to claim 1,
machining each stave wood from this batch to form identical staves having the same configuration without removing material from the free face of the first layer of wood apart from its ends in order to form bevels and kerfs or crozes in the corresponding stave.
